(19) United States
(12) Patent Application Publication
(10) Pub. No.: US 2011/0242439 A1
(43) Pub. Date: Oct. 6, 2011

(54) APPARATUS FOR PROVIDING TELEVISION AND CONTROL UNIT MOUNT

(75) Inventors: RAFAEL CALDERON, SAN DIEGO, CA (US); JONATHAN HOGANDER, SAN DIEGO, CA (US); TOMOKO NISHIOKA, SPRING VALLEY, CA (US); KEITH RESCH, SAN DIEGO, CA (US)

(73) Assignee: SONY CORPORATION, Tokyo (JP)

(21) Appl. No.: 12/751,688

(22) Filed: Mar. 31, 2010

(51) Int. Cl. H04N 5/64

(52) U.S. Cl. 348/836; 348/E05.128

(57) ABSTRACT

An apparatus for providing a television and control unit mount. The apparatus comprises a television display, a control unit, and a mount. The mount attaches the television display to a wall and provides a base for the control unit when the television display is coupled to a pedestal mount.

### BACKGROUND

1. Field of the Invention

Embodiments of the present invention generally relate television mounting brackets and, more particularly, to an apparatus for providing a television and control unit mount.

2. Description of the Related Art

As display technology has advanced, television form factors have shrunk. Plasma displays and Liquid Crystal displays (LCDs) with a footprint no larger than a picture frame are common in today's homes and offices. Mounting apparatuses allow these displays to be hung on a wall like a picture, freeing up floor space that would otherwise be occupied by a stand. However, in some cases, it may not be possible to mount the television on a wall. For this reason, a pedestal mount is also commonly provided with the display.

In many instances, the mounting bracket for the display is sold separately from the display itself. These mounting brackets are designed to be positioned behind the televisions as they are hung and may be large and unsightly. Providing a wall mount to a customer who intends to use a pedestal mount creates a storage problem. If the mount is stored close to the display, it may prove unsightly and clutter the area. If the mount is stored in a separate location, it may be mislaid or inconvenient in the event the display needs to be hung. Therefore, there exists a need in the art for an apparatus for providing a television and control unit mount.

### SUMMARY OF THE INVENTION

Embodiments of the present disclosure generally include an apparatus for providing a television and control unit mount. The apparatus comprises a television display, a control unit, and a mount. The mount attaches the television display to a wall and provides a base for the control unit when the television display is coupled to a pedestal mount.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a television display and pedestal mount in accordance with embodiments of the present invention;

FIG. 2 is a block diagram illustrating a television mount and display system on a pedestal mount in accordance with embodiments of the present invention;

FIG. 3 is a block diagram of a television wall mount in accordance with embodiments of the present invention; and

FIG. 4 is a block diagram of a television display mounted on a wall via a wall mount in accordance with embodiments of the present invention.

### DETAILED DESCRIPTION

As explained further below, various embodiments of the invention disclose an apparatus for providing a television and control unit mount. The apparatus comprises a television display, a television wall mount, a control unit, and a television pedestal mount. The television wall mount comprises an interface for the control unit and the pedestal mount, and an interface for the television display and a wall. The television wall mount couples the control unit to the pedestal mount. In this manner the television all mount is included in the aesthetics of the entire television system, obviating the need to store the mount in a separate location. In the event the user wishes to mount the display on the wall, they can decouple the wall mount from the control unit and pedestal.

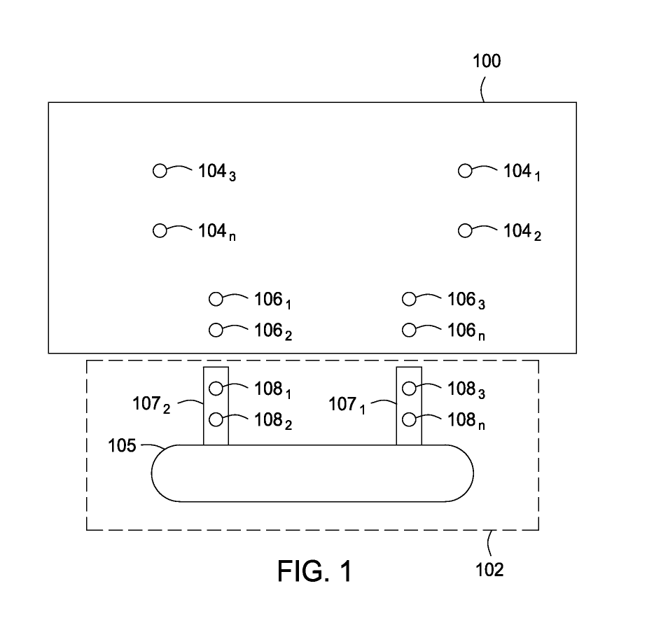

FIG. 1 illustrates a television display 100 and pedestal mount 102 in accordance with embodiments of the present invention. The television display 100 is a standard display such as generally known in the art, such as a LCD, plasma display, light emitting diode (LED) display, cathode ray tube (CRT) display, and the like. While the present embodiment of the invention is discussed with respect to television displays, one of ordinary skill in the art would recognize that the invention could be adapted to computer monitors and other display devices. The television display 100 displays images received from an external source. In some embodiments, the television display 100 may include internal speakers to provide sound to accompany the image. In some embodiments, sound may be provided by an external source. The television display 100 further comprises one or more wall mount interface points 104₁, 104₂, . . . , 104ₙ and one or more television pedestal mount interface points 106₁, 106₂, . . . , 106ₙ. In some embodiments, the wall mount interface points 104 are standard threaded holes as known in the art, suitable for bolts, screws, and other fasteners as known in the art. The wall mount interface points 104 provide an interface for one or more fasteners to couple the television display 100 to a wall mount as known in the art. In some embodiments, the wall mount interface points 104 are arranged in a Video Electronics Standards Association (VESA) pattern, as known in the art. The process of mounting the television display to the wall mount is discussed further with respect to FIGS. 3 and 4.

The pedestal mount 102 is a stand for the television display as generally known in the art. The pedestal mount 102 allows for the television display to be placed on a flat surface such as a floor, entertainment center, television stand, and the like. The pedestal mount 102 is comprised of a flat base 105 and one or more television interfaces 107. The television interfaces 107 attach to the television display 100 and provide support to allow the television display 100 to remain upright. In some embodiments, the television interfaces 107 are attached to the back of the television 100. In some embodiments, the television interfaces 107 are placed inside of the television 100 via interface holes present on the bottom of the television display 100. The television interfaces 107 comprise one or more pedestal mount television interface points 108₁, 108₂, . . . , 108ₙ. The pedestal mount television interface points 108 align with the pedestal mount interface points 106 for coupling the television display 100 to the pedestal mount 102. In some embodiments, a fastener such as a bolt, a screw, a peg, and the like is placed through the aligned set of pedestal mount television interface points 108 and television pedestal mount interface points 106 to couple the television display 100 to the pedestal mount 102.

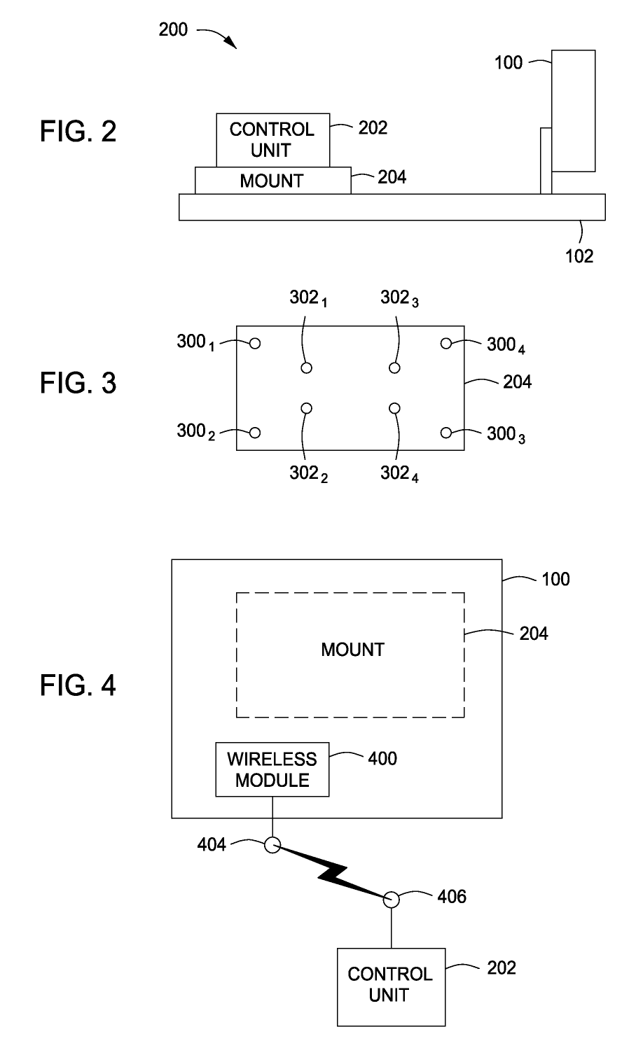

FIG. 2 is a block diagram of a system 200 using an embodiment of the present invention. The system 200 comprises a television display 100, a pedestal mount 102, a control unit 202, and a mount 204. The television display 100 is coupled to the pedestal mount 102 in the manner discussed with respect to FIG. 1. The control unit 202 provides display functionality to the television display 100. This functionality may be provided by various support circuits including a television tuner, an antenna, and various inputs and outputs such as coaxial, component video, digital audio, analog audio and video, high definition multimedia interface (HDMI), universal serial bus (USB), and any other inputs and outputs as known in the art. In some embodiments the control unit 202 provides signal decryption and image scaling functionality for the television display 100. In some embodiments the control unit 202 may further comprise a digital video recorder (DVR) module including a local memory for storing video for display on the television display 100. The control unit 202 may also provide an interface for various remote control devices to control the television display 100. In some embodiments the control unit 202 provides outputs to various other devices, such as audio output to a sound system.

The control unit 202 may be coupled to the pedestal 102 by a mount 204. The mount 204 may also be used as a wall mount for the television display, and coupling the control unit to the pedestal 102 in this manner provides for convenient storage in an aesthetically pleasing manner. In some embodiments, the control unit 202 is fastened to the mount 204 in a similar manner to which the television display 100 is fastened to a wall or pedestal mount. In some embodiments, the control unit 202 rests on the mount 204 and interfaces with the mount via a system of pegs and holes or similar gravity mounted configuration. The use of the mount 204 as a wall mount is discussed further with respect to FIGS. 3 and 4.

The control unit 202 may communicate with the television display 100 in accordance with communications protocols as generally known in the art. In some embodiments, the control unit 202 is coupled to the television display 100 by one or more wires for providing audio, video, and/or control functionality. In some embodiments, the control unit 202 communicates with the television via wireless protocols as generally known in the art.

FIG. 3 is a block diagram of a mount 204 in accordance with embodiments of the present invention. The mount 204 provides both wall-mount functionality for the television display 100 and a base for the control unit 202 to attach the control unit 202 to the pedestal 102. The mount 204 comprises a first set of interface points 300₁, 300₂, . . . , 300ₙ and a second set of interface points 302₁, 302₂, . . . , 302ₙ. In some embodiments, the first set of interface points 300 is used to provide an interface for mounting the mount 204 on a wall for hanging the television display 100. The first set of interface points 300 also provides an interface for the mount 204 to be attached to the pedestal 102 when the mount 204 is not coupling the television display 100 to a wall. The second set of interface points 302 is used to fasten the mount 204 to the television 100 via the wall mount interface points 104. In some embodiments the mount 204 may include an arm between a back plate containing the first set of interface points 302 attaching the mount 204 to the wall. The arm may allow for the television display 100 to rotate away from the wall in a manner consistent with practices generally known in the art. When the mount 204 is not used to attach the television display 100 to the wall, the second set of interface points 302 attaches the control unit to the mount 204 in the manner as discussed with respect to FIG. 2. One of ordinary skill in the art would recognize that the roles of the first and second sets of interface points could be switched, with the first set of interface points 300 providing an interface for the control unit to the mount 204 and the second set of interface points 302 attaching the mount 204 to the pedestal 102. The same switch could be performed with respect to the roles of the first and second set of interface points 300 and 302 in the mounting of the television display 100 to the wall.

FIG. 4 is a block diagram of a television display 100 attached to a wall in accordance with embodiments of the present invention. The television display 100 is attached to the wall via the mount 204 in the manner as discussed with respect to FIG. 3. The television display 100 further comprises a wireless module 400 and a wireless antenna 404. The wireless module 400 communicates with the control unit 202 to provide control, audio, and/or display functionality for the television display 100 as discussed with respect to FIG. 2. The control unit 202 further comprises a wireless antenna 406 for sending and receiving wireless data to the television display 100.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. An apparatus for providing a television mount and a control unit mount comprising:
a television display;
a control unit;
a pedestal mount; and
a mount for attaching the television display to a wall, wherein the mount provides a base for the control unit when the television display is coupled to the pedestal mount.

2. The apparatus of claim 1, wherein the mount further couples the control unit to the pedestal mount when the television display is coupled to the pedestal mount.

3. The apparatus of claim 1, wherein the control unit further comprises a wireless module for communicating with the television display.

4. The apparatus of claim 1, wherein the mount further comprises an arm for providing a swivel mount for the television display.

5. The apparatus of claim 1, wherein the mount further comprises a first set of interface points for coupling the television display to the mount and for coupling the control unit to the mount.

6. The apparatus of claim 5, wherein the mount further comprises a second set of interface points for coupling the mount to the wall and for coupling the mount to the pedestal mount.

7. The apparatus of claim 1, wherein the mount is compliant with the video electronics standards association wall mount standards.
